(19) United States
(12) Patent Application Publication
(10) Pub. No.: US 2005/0288259 A1
(43) Pub. Date: Dec. 29, 2005

(54) Composition

(76) Inventors: Barry Charles Hosking, New South Wales (AU); Walter Oechslein, Harpolingen (DE)

Correspondence Address: NOVARTIS;CORPORATE INTELLECTUAL PROPERTY, ONE HEALTH PLAZA 104/3, EAST HANOVER, NJ, 07936-1080, US

(21) Appl. No.: 10/533,985

(22) PCT Filed: Nov. 13, 2003
(86) PCT No.: PCT/EP03/12708

§ 371 Date: May 5, 2005

(30) Foreign Application Priority Data
Nov. 14, 2002 (EP) 020253845

(51) Int. Cl. A01N 57/00; A01N 25/00

(52) U.S. Cl. 514/114; 424/405

(57) ABSTRACT

The present invention relates primarily to an effective long-term simultaneous control of louse infestations and prevention of blowfly strikes on sheep and goats using a specific oil-in-water or water-in-oil topical suspoemulsion formation comprising an insecticidally effective amount of each of the two active ingredients diflubenzuron and dicyclanil and sutiable carriers or diluents.

The present invention relates preferably to a convenient, easy-to-use, safe, powerful, and long lasting formulation for simultaneously controlling louse infestations and preventing blowfly strikes on sheep. It may also be useful for controlling similar infestations on goats.

### FIELD OF THE INVENTION

While only a simple nuisance to humans, parasitic flies commonly referred to as blowflies (for example Lucilia cuprina, L. sericata, Chrysomyia rufifacies, Calliphora stygia) cause tissue damage (technically known as cutaneous myiasis) that can lead to meat production and reproduction losses, and poorer wool quality and quantity. Left uncontrolled cutaneous myiasis can be serious enough to lead to the death of an infested animal. Because there are significant animal welfare and financial issues to be considered farmers are highly interested in preventing blowfly infestations within their flocks of sheep. The key for controlling the problem is preventing infestations by interrupting the blowfly life cycle, which is not satisfactorily achieved with most of the existing products.

Sheep lice and specifically the body louse, Bovicola ovis (=Damalinia ovis) can cause considerable damage to the wool of infested sheep. Infestation's impact significantly on the quality and quantity of wool that can be harvested from sheep. Sheep louse infestations will reduce the quantity of good, clean wool and cause fleeces to become cotted and discolored. This reduces the yield and increases losses during subsequent wool processing. Sheep body lice have also been shown to cause a defect in sheep leather known as “cockle”. Cockle manifests as multiple discolored lumps on the pelt that are only visible after processing.

The financial loss to a farmer arising from a reduced income from wool damaged by lice can be as much as 64% of what could have been earned if no lice were present. Thus there is a requirement to have a product that consistently and effectively controls sheep body lice.

There are many products on the market for controlling insect parasites of sheep. However, most of them show certain disadvantages concerning, for example, their spectrum of activity, the duration of the activity, their safety or their ability to persist for an acceptable period of time in the wool. Many products are also disadvantaged if rainfall occurs, either just before treatment or soon after treatment. The commercially available insecticides vary in their effectiveness against any particular insect species. Often the efficacy of these insecticides is not always satisfactory because of, for example, the development of resistance by the parasite to the therapeutic agent, as is the case, for example, with carbamates, organophosphorus compounds and pyrethroids. An effective resistance management programme is clearly needed by the sheep farming industry. Included in this programme should be a product that combines the power of two effective therapeutic agents, which will help delay the onset of resistance by some insects to the agents. Thus, there is clearly a long felt need for a convenient, easy-to-use, safe, powerful, and long lasting product that does not lead to the development of resistant insects, especially blowflies, within a few years. Moreover, there is at the present time no truly effective easy-to-use product that provides efficient and long lasting simultaneous control of blowflies and lice. Thus, there is a real demand in the art for a more effective antiparasitic formulation for the treatment and the protection of sheep (and perhaps goats) against both blowfly strike and louse infestation. Moreover, there is a need in the art for an antiparasitic formulation which is easy to use on sheep, irrespective of their size and the nature of their wool and which does not need to be applied over the entire body of the animal to be effective.

### BACKGROUND OF THE INVENTION

Massive cutaneous myiasis or blowfly larval (maggot) infestations (often referred to as blowfly strike or flystrike) on sheep are found particularly frequently in geographic areas that have a warm, humid climate. This is why numerous species of blowfly that cause flystrike occur throughout New Zealand and Australia as well as in North and South American countries, certain European countries and in Africa. There is also evidence that the blowfly (for example L. cuprina) will continue to extend its habitat into new areas. In New Zealand, for example, the relatively recent introduction of this aggressive blowfly has subsequently led to migration at a rapid speed southward through the country affecting most areas except perhaps the far south.

Myiasis can be extremely harmful, depending upon the species of fly and the circumstances surrounding the infestation. The larval or maggot stage of for example, L. cuprina or L. sericata constitutes the real animal parasite. The life cycle of L. cuprina is described and demonstrates the horrific nature of the resulting disease and the speed with which fly populations can increase if the parasite is left uncontrolled.

The life cycle of L. cuprina starts with the female laying about 200 eggs on the sheep. First instar maggots, about 1 mm long, will emerge within 12 hours and feed in damp fleece, in lumpy wool, fleece-rot lesions, in and around wounds, or in fecal soiling. These first instar maggots have no rasping mouthparts and so are not capable of damaging the skin. It is preferable therefore to control the life cycle at this point. Under favorable conditions the first instar will molt to the second instar about 18 hours after hatching. This molting process allows the maggot to grow. After a second molt, about 36 hours after hatching, the third instar maggots will be very active and feeding voraciously. These maggots rasp the sheep's skin with their mouthparts and produce enzymes that liquefy the skin and tissues of the affected animals. This process also attracts further strikes. During this feeding period the maggots grow very quickly and they will be fully fed within 3-4 days of hatching. At full size the maggots are about 12 mm long, creamy white and very active. They drop from the sheep, usually at night, and burrow into the top few centimeters of soil. If the soil temperature is less than 15° C., development may cease at this stage, otherwise pupation will occur. During pupation, chemical changes in the maggot's skin transform it to a rigid barrel-shaped cocoon or pupa. Inside the cocoon, the maggot metamorphoses into a fly. Under ideal conditions a young fly will emerge from its pupa 12-14 days after the egg from which it was derived was laid. The young female fly will be very active in searching for food as she needs several protein feeds so her eggs can mature. After the feeding process she actively seeks sites suitable for egg-lay. She will mate only once, usually about three days after she has emerged from her cocoon. A female Lucilia has an average life span of about 2-4 weeks in warmer months and considerably longer in cooler months. During her life, she may lay up to three batches of eggs.

The sheep body louse is a biting insect that feeds on skin scurf, wool grease, sweat secretions, superficial cells of the stratum corneum and skin bacteria. Lice stimulate numerous responses in sheep. They cause a pruritic behavior (rubbing, biting and scratching). This is a major reason for the reduction in wool quantity and quality. This rubbing, biting and scratching behavior is unlikely to have any effect on the lice as they are protected from its effects by the dense covering of wool present on sheep at most times of the year. Unless a flock of louse infested sheep is treated with an effective lousicide, a seasonal pattern in louse numbers occurs with lice building up in the cooler months of autumn, winter and spring but declining again in summer. The life cycle of B. ovis is described.

Females cement eggs to wool fibers, mostly at 6-12 mm from the skin. The eggs hatch into the first juvenile (nymphal) stage and then a series of molts occur. There are three nymphal stages and one adult stage in the life cycle. The time for the three nymphal stages on sheep is approximately 5, 7 and 9 days, respectively although this can vary a bit between strains. Female lice will mate within a few hours of molting to adults but there is normally a 3-4 day pre-ovipositional period. Females lay eggs at a maximum rate of about one egg every 36 hours. There are approximately equal numbers of male and female lice and the length of a complete life cycle from egg to egg is 34-36 days under normal conditions. Female lice live an average of 28 days and males, 49 days.

If only several moderately infested sheep are present in a large flock the spread of the louse infestation through the flock would occur slowly in the early stages of infestation and it may take numerous months for a high percentage of the flock to develop a detectable infestation. However, once this stage is reached, build up to a heavy infestation will occur rapidly. Once fleece derangement or rubbing sheep are noted in a flock, an infestation is probably already well established.

Sheep lice will only breed on sheep and complete their entire life cycle on the animal. However, this parasite can be transferred to goats and survive the remainder of its normal life span on the goat. A prerequisite for this transfer to another host is that sheep and goats are kept very close together, for example, in the same yard or pasture. Sheep lice will not breed on goats and are very unlikely to be the cause of re-infestation. Sheep lice will not transfer to any other animal species. Infestation usually takes place by direct and prolonged contact between infested and uninfested animals.

It is preferable to use therapeutic chemicals to control louse infestations on sheep at strategic times, and specifically soon after the wool is harvested. By treating the sheep with a suitable product, such as the invention, the farmer can be reliably assured that the louse population will be controlled for a long period of time.

Similarly the strategic use of therapeutic chemicals to prevent blowfly Infestations should occur. Ideally a product, such as the invention, would be applied following wool harvest in the spring (or autumn in some geographic zones) such that when the first generation of flies emerges from the soil in the new fly season, their life cycle would be immediately broken when they come into contact with preventively treated sheep.

### SUMMARY OF THE INVENTION

The Applicant has found that it is possible to obtain effective long-term simultaneous control of louse infestations and prevention of blowfly strikes on sheep and goats using a specific topical formulation.

The aim of the present invention is thus to provide a novel composition which is entirely effective against sheep lice and blowfly, this composition being entirely suitable for controlling these parasites under the conditions in which these animals are reared.

Another aim of the invention is to provide such a formulation, which has a long period of efficacy against blowflies and body lice, preferably longer than or equal to five months.

Another aim of the invention is to provide such a formulation, which is convenient, quick and easy-to-use and entirely compatible for use on flocks containing a large number of animals.

Yet another aim of the invention is to provide such a formulation, which applies reduced chemical to the “fleece” wool yet maintains long lasting effective control, especially of sheep body lice.

Another aim of the invention Is to provide such a formulation, which is particularly suitable for extensive pasture rearing of sheep (or goats). In such instances, which are very common, the effects of climate (especially rainfall) can have an adverse effect on the longevity of the chemical residues in the fleece. Some current products are particularly vulnerable to removal from the fleece by rainfall thus reducing the protection period against the target parasite. An aim of the invention is to provide such a formulation that can tolerate rainfall.

Yet another aim of the invention is to provide a process for producing said inventive topical formulation.

### DETAILED DESCRIPTION OF THE INVENTION

It has now surprisingly been found that the discussed disadvantages of the existing products can be overcome and other advantageous properties can be achieved with a combination of two known insecticides, dicyclanil and diflubenzuron.

The best results are achieved if the combination of dicyclanil and diflubenzuron is formulated and administered in the right manner.

Thus, the present invention makes use of the following two known insecticides, dicyclanil and diflubenzuron.

Dicyclanil is 4,6-diamino-2-cyclopropylaminopyrimidine-5-carbonitrile and is described in U.S. Pat. No. 4,783,468. It shows the following chemical structure:

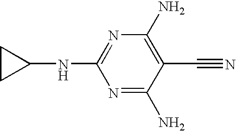

Dicyclanil is a pyrimidine derivative that is sold under the trade name Clik®. It is available in the form of a spray-on formulation applied to the backline and breech of sheep and is dosed according to bodyweight. While the exact mode of action for dicyclanil is not precisely known, it is understood that it interferes with how chitin is deposited into the cuticle of fly larvae. In Australia, Clik® provides 18-24 weeks protection against flystrike but has the extreme disadvantage that it does not kill lice. Protection periods in other countries are shorter. Dicyclanil interferes with the molting process of blowfly larvae, killing 1^{st} stage larvae very readily. The effect on 2^{nd} stage larvae and to a greater degree, 3^{rd} stage larvae are less pronounced and the product may take more time to resolve an active flystrike.

Diflubenzuron, which is 1-(4-chlorophenyl)-3-(2,6-difluorobenzoyl)urea is described in U.S. Pat. No. 3,748,356. It shows the following chemical structure:

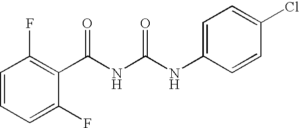

Diflubenzuron is a substituted benzoylphenylurea that inhibits the deposition of chitin in the insect cuticle. It is or has been sold under, for example, the trade names Dimilin®, Micromite®, Vigilante®, and Duphacid®. Diflubenzuron is widely used in plant protection as a non-selective broad range insecticide and in animal health primarily as a lousicide for sheep and cattle. It has some activity against sheep blowflies but has an inherent disadvantage that some strains of fly demonstrate a cross-resistance between diflubenzuron and some of the organophosphorus compounds, especially diazinon. The levels of diazinon resistance in some blowfly populations, especially L. cuprina are very high. Thus, diflubenzuron when used as a single entity for blowfly control is vulnerable to an undesired and premature loss of control. The insecticidal action of diflubenzuron is due to interaction with chitin synthesis and/or deposition. It interferes with the endocrine mechanisms (ecdysone functions) that regulate chitin production. A failure to synthesize chitin halts molting in the juvenile stages of parasites. This leads to physiological difficulties, desiccation, and ultimately to the death of the insect.

Pesticidal combination products wherein one component is diflubenzuron or dicyclanil are already described in the art.

WO0237964 discloses combinations of pesticides wherein one component is N-Cyanomethyl-4-trifluoromethyl-3-pyridine carboximide that has the following chemical structure 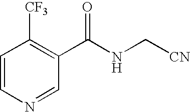
and the other component could be selected from abamectin; azamethiphos; bromopropylate; chlorfenvinphos; cypermethrin, cypermethrin high-cis; cyromazin; diafenthiuron; diazinon; dicrotophos; dicyclanil; emamectin; fenoxycarb; lufenuron; methidathion; monocrotophos; profenofos; pymetrozine; tau-fluvalinate; thiamethoxam; azoxystrobin; bensultap; chlorothalonil; fenpyroximate; fluazinam; flufenprox; flutriafol; lambda-cyhalothrin; phosmet; picoxystrobin; primicarb; pyridaben; or tefluthrin. A combination wherein the two components are diflubenzuron and dicyclanil is not disclosed.

WO0205639 is directed to pesticidal composition for local application to an animal comprising an insect growth regulating insecticide (IGR) and a solvent system comprising an aromatic hydrocarbon solvent and/or a propylene glycol monoalkyl ether and/or a pyrrolidone solvent. The IGR insecticide is selected from one or more of diflubenzuron, dicyclanil, lufenuron, novaluron, triflumuron, and cyromazine. Apart from the IGR the pesticidal composition may contain a pesticide that exhibits an immediate “knock down effect” e. g. a synthetic pyrethroid (e.g. permethrin, deltamethrin, cypermethrin, lambdacyhalothrin, fenvalerate, resmethrin, tralomethrin), acetylcholinesterase inhibitors as carbamates (e. g. carbaryl, benziocarb, fenoxycarb, proxopur), or organophosphates (e. g. dichlorvos, dimethoate, cythioate, fenthion, fluthion, tetrachlorvinos, chlorpyrifos, coumaphos, diazinon, phosmet, parathion, trichlorfon, temephos), acetylcholine mimics (e. g. nicotine, immidacloprid), GABA antagonists (e. g. fipronil and amitraz). No binary system is disclosed.

WO9932088 is directed to a topically acceptable aqueous pour-on formulation adapted for localized external application to an animal, which format includes an effective amount of a water insoluble insect growth regulator (IGR) preferably selected from the group consiting of diflubenzuron, triflumuron, fluazuron, and methoprene, a suspending agent, a surfactant or mixture of surfactants, and an aqueous carrier. WO9932088 does not refer to dicyclanil. Similar to WO9932086 this reference mentions that other ingredients may be suitably included, for example actives which have an immediate effect, i.e. “knock down”.

WO9932086 is directed to a pour-on formulation of an insect growth regulator (IGR) insecticide, and a method of treating or controlling insects and parasites on animals. In particular, the present invention relates to a pour-on formulation of a water insoluble IGR in a non-aqueous blend of solvent(s) and surfactant(s). Suitable IGRs include diflubenzuron, triflumuron, fluazuron, and methoprene. Other ingredients that may be included in the formulations of the present invention are: actives which have an immediate “knock down effect” (e.g. synthetic pyrethroids or organophosphates); antioxidants (e. g. Vitamin E); UV protectants (e. g. oxybenzone); perfumes; and thickeners (e. g. polyvinyl pyrrolidone).

G. W. LEVOT “Insecticide Resistance: New development and future options for fly and lice control on sheep” Wool Tech. Sheep Breed., Vol. 41, No. 2, 1993, 108-119 deals with “Insect resistance: New Developments and Future Options for Fly and Lice Control on Sheep”. This reference describes the problems woolgrowers are faced with due to growing resistance against certain insecticides and residues in the wool. Amongst other insecticides diflubenzuron is considered as a promising candidate that might help solving said problems.

Whereas the prior art proposes a combination of an IGR and a “knock down insecticide” the present invention deals with the combination of two different IGRs in oil-in-water or water-in-oil suspoemulsion formulations, that unexpectedly solve the resistance and residue problems indicated above and exhibit further beneficial properties described hereinafter. These two different IGRs are dicyclanil and diflubenzuron.

Dicyclanil and diflubenzuron belong to different chemical families but are loosely grouped into a large class commonly known as “insect growth regulators”. Importantly both compounds interfere differently with the various development stages of insects. In vitro experiments against diflubenzuron-resistant and diflubenzuron-susceptible strains of L. cuprina demonstrate that the inventive combination of active ingredients shows surprisingly full activity if administered in the same ratio as is contained in the inventive product. The invention makes use of the fact that dicyclanil will control the strains of blowfly that diflubenzuron is ineffective against.

Fly larvae belonging to a diflubenzuron-susceptible strain (LS) and a diflubenzuron-resistant strain (Emmaville) of L. cuprina are tested. First stage larvae are exposed to differing concentrations (aimed to achieve 0-100% prevention of adult fly emergence) of dicyclanil, diflubenzuron or a combination of the two actives (at the ratio used in the invention). The number of larvae forming pupae and the number of pupae producing viable adult flies are recorded. The level of diflubenzuron resistance in the Emmaville strain prevents achieving complete inhibition of adult fly emergence with diflubenzuron. Maximum mortality is 41% at 300 mg diflubenzuron/kg. The limit of solubility of diflubenzuron precludes the testing of higher concentrations. The Emmaville strain response to dicyclanil is typical of a susceptible strain (LS) confirming that dicyclanil Will control diflubenzuron-resistant strains of L. cuprina.

Moreover, if any particular fly strain is susceptible to the therapeutic actions of both compounds, then this provides an extreme advantage In that the development of resistance to either compound by the blowfly will be significantly delayed.

The present invention also makes use of the discovery that topical administration of the combination of the two different IGRs dicyclanil and diflubenzuron in oil-in-water or water-in-oil suspoemulsion formulations surprisingly leads to excellent results with regard to the efficacy (discussed later in this document), tolerability, residue effects and ease of handling. Furthermore, the invention is better than or equally tolerant to rainfall than the commercial spray-on products containing diflubenzuron or dicyclanil as single entities that it was evaluated against. This can be demonstrated with experiments designed to evaluate the effect that rainfall has on the removal of residues from the wool of sheep. In said experiment the sheep are treated with the product allocated to their respective group and on four occasions after treatment the sheep are exposed to heavy artificial rainfall. Seven weeks after treatment, wool specimens are collected from the sheep and analyzed for residues. The mean recoveries of diflubenzuron from specimens of wool from sheep treated with the invention are consistently better than those recovered from similar wool collected from sheep treated with a commercial diflubenzuron product. The mean concentration of dicyclanil in specimens of wool from sheep treated with the invention is equal to or even better than those obtained with a commercial product.

This tolerance of rainfall is extremely advantageous and important for the farmer who can treat sheep with the confidence that the invention will work, irrespective of the weather conditions.

The safety of the invention to the target animal species can be evaluated in a “margin-of-safety” study. In such a study, sheep are treated with the test product at up to five times the maximum dose rate and numerous blood biochemical, hematological and veterinary physical parameters evaluated over a 21-day period after treatment. Throughout such a study, sheep appeared to be clinically normal and in good health after treatment with the invention at one, two and five times the maximum dose rate.

Tissue residue studies are carried out to determine the period after treatment where the produce of treated animals cannot be used for human consumption. The proposed maximum dose rate for the invention is used in this evaluation. Sheep are treated with the invention at the commencement of the study and at pre-defined intervals thereafter, groups of sheep are humanely sacrificed and the appropriate target tissues (liver, kidney, muscle, fat) are recovered and subsequently analyzed (under Good Laboratory Practice conditions) for the presence of active ingredients (and their metabolites if necessary).

The residue definition for dicyclanil in Australia is the sum of dicyclanil and its metabolite CGA 297′107. Considering this, in the course of this study the mean maximum residue concentrations were detected at two and three weeks post-treatment. Mean group values (mg/kg dicyclanil) are presented in the table.

| Week* | Muscle | Kidney | Liver | Renal fat | Sub. fat |
|---|---|---|---|---|---|
| 2 | <0.02 | 0.04 | 0.04 | <0.02 | 0.09 |
| 3 | 0.03 | 0.06 | 0.04 | <0.02 | 0.03 |
| 4 | <0.02 | <0.02 | <0.02 | <0.02 | <0.02 |
| 5 | <0.02 | <0.02 | <0.02 | <0.02 | <0.02 |
| 6 | <0.02 | <0.02 | <0.02 | <0.02 | <0.02 |
| 17 | <0.02 | <0.02 | <0.02 | <0.02 | <0.02 |

*post-treatment

The residue definition for diflubenzuron in Australia is expressed as only diflubenzuron. In this study there were no detectable residues in individual tissues (liver, kidney, subcutaneous fat, renal fat) from any animal above the Limit of Quantitation (0.025 mg/kg) at 2, 3, 4, 5, 6 or 17 weeks after treatment.

It is true that diflubenzuron is known as an anti-louse product, and dicyclanil is known as an anti-blowfly product with a pronounced preventive activity. However, while the biological profile of the insecticides is well known, and it is generally known in the art that it is sometime=es possible to combine insecticides in order to broaden the insecticidal spectrum, it is not predictable, a priori, which combinations will work for a particular animal or disease state. Furthermore It is not known which combination in which formulation will actually lead to the desired effect without causing unacceptable side effects. It cannot be foreseen whether the combination of two insecticides that exhibit totally different modes of action will influence each other in a favorable manner or even show antagonistic effects. Insecticides are compounds that have to kill insects and insects are highly developed organisms. Insecticides are applied to sheep that are even more developed animals. Therefore, it is simply not predictable what effect combinations of differently acting insecticides will actually cause in the insect or in the sheep. There is always the risk that the combination may be too toxic or lead to complications that cannot be tolerated. For these reasons, the results of various combinations are not always successful and there is a need in the art for more effective formulations that may be easily administered to the animal and which are well tolerated by the animal whilst killing the parasites for an extended period. The pharmacokinetic behavior of a combination can be totally different than the pharmacokinetic behavior of the single products. The same is true for residue aspects. It can simply not be predicted how a combination behaves even though the behavior of the single components might well be known. One product could be accumulated in the wool and stay there for an unacceptable period of time, the other may stay in a specific tissue or organ or both may accumulate in specific tissues and cause health problems. The effectiveness of a given formulation against blowflies and lice in a specific host is difficult to predict because of the numerous and complex host-parasite-environment interactions and the complex biological and chemical conditions in the animal's body and fleece.

Thus, the main subject of the present invention is a safe and well-tolerated topical formulation in the form of a spot-on, pour-on or preferably spray-on. It is intended to simultaneously control, with extreme efficiency, lice and blowfly on sheep and then protect the sheep from re-infestation by the parasites for a prolonged period. The invention comprises a combination of dicyclanil, diflubenzuron (the active ingredients), carriers suitable for spreading the active ingredients all over the skin and preservatives that ensure an effective and long shelf life.

So far blowflies and lice have had to be effectively controlled by different products and in cases, different application methods and times of treatment. Thus, a real advantage of the inventive formulation is that a one-shot administration leads to a long lasting action against blowflies and lice. This reduces the workload, the costs, and the animals are stressed significantly less.

The expression topical formulations are understood to refer to a ready-to-use solution in form of a spot-on, pour-on or spray-on formulation consisting of a dispersion or suspoemulsion intended to be applied directly to a relatively small area of the sheep, preferably on the animal's back and breech or at several points along the line of the back and breech. It is applied as a low volume of about 0.5 to 1 ml per kg, preferably about 0.5 ml per kg, with a total volume from 10 to 50 ml per animal, preferably limited to a maximum of about 40 ml.

The combination of dicyclanil and diflubenzuron is extremely effective. Therefore, it is not necessary to add further insecticides into the topical formulation according to the present invention. Thus, one main objective of the present invention is providing a combination product for controlling insect pests on mammals comprising a insecticidally effective amount of diflubenzuron and dicyclanil and suitable carriers or diluents. Especially preferable are combinations in the form of a topical formulation for simultaneously controlling louse infestations and preventing blowfly strikes on sheep (and goats) comprising an insecticidally effective amount of each of the two active ingredients diflubenzuron and dicyclanil and suitable carriers or diluents.

The topical formulations according to the invention are advantageously oil-in-water or water-in-oil suspoemulsions comprising both active ingredients, viz. diflubenzuron and dicyclanil and suitable carriers or diluents.

More specifically, the topical formulation of the present invention is a pour-on, spot-on or spray-on formulation consisting of an aqueous suspoemulsion containing an insecticidally effective amount of each of the two active ingredients diflubenzuron and dicyclanil and further comprising at least a surfactant, an emulsifier, a preservative, a synergist, an antioxidant, an oily component, a solvent, a thickener, a neutralizer, and optionally one or more excipients selected from the group consisting of a coloring agent, and an antifoaming agent.

In a preferred embodiment of the present invention the inventive formulation comprises diflubenzuron in the range of 0.05-2.5% (w/v), preferably 1.0-2.0% (w/v), ideally about 1.5% (w/v), and dicyclanil in the range of 4.0-6.0% (w/v), preferably 4.5-5.5% (w/v), ideally about 5% (w/v).

In another embodiment of the present invention the inventive formulation comprises the surfactant in the range of 0.15-10.0 % (w/v), preferably 0.2-4.0% (w/v), ideally about 0.25% (w/v).

Examples of suitable surfactants of the preferred embodiment include but are not limited to anionic, cationic and amphoteric surfactants, as well as combinations thereof, and derivatives thereof. Said surfactants are widely used as solvents in the cosmetic and pharmaceutical industries.

Suitable anionic surfactants are alkaline stearates, in particular sodium, potassium or ammonium stearates; calcium stearate, triethanolamine stearate; sodium abietate; alkyl sulphates, in particular sodium lauryl sulphate and sodium cetyl sulphate; sodium dodecylbenzenesulphonate, sodium dioctylsulphosuccinate; fatty acids, in particular those derived from coconut oil.

Suitable cationic surfactants are water-soluble quaternary ammonium salts of formula N⁺ R1, R2, R3, R4, Y⁻ in which the radicals R1 to R4 are optionally hydroxylated hydrocarbon radicals and Y⁻ is an anion of a strong acid such as the halide, sulphate and sulphonate anions; cetyltrimethylammonium bromide is among the catonic surfactants which can be used, amine salts of formula N⁺ R1, R2, R3 in which the radicals R1 to R3 are optionally hydroxylated hydrocarbon radicals; octadecylamine hydrochloride is among the cationic surfactants which can be used.

Suitable nonionic surfactants are sorbitan esters, which are optionally polyoxyethylenated, in particular polysorbate 20, polysorbate 65, polysorbate 80, polyoxyethylenated alkyl ethers; polyoxypropylated fatty alcohols such as polyoxypropylene-styrol ether; polyethylene glycol stearate, polyoxyethylenated derivatives of castor oil, polyglycerol esters, polyoxyethylenated fatty alcohols, polyoxyethylenated fatty acids, copolymers of ethylene oxide and propylene oxide.

Suitable amphoteric surfactants are the substituted lauryl compounds of betaine; Most preferred is polysorbate 20.

Polysorbates are made by reacting ethylene oxide (a gas) with sorbitan esters (derivatives of sorbitol, another sugar alcohol similar in function to mannitol). Synonyms of polysorbate 20 are: polyoxyethylene sorbitan monolaurate E432; and polysorbate 20 NF (CAS No.: 9005-64-5), and, tween 20. This product is a non-ionic surfactant that is used to disperse and emulsify. Polysorbate 20 is indispensable for oil in water emulsions, such as lotions, conditioners and cream rinses.

In another embodiment of the present invention the inventive formulation comprises the emulsifier in the range of 0.01-0.30% (w/v), preferably 0.05-0.15% (w/v), ideally about 0.08% (w/v).

Examples of suitable emulsifiers of the preferred embodiment include but are not limited to, non-ionic surfactants, for example polyoxyethylated castor oil, polyoxyethylated sorbitan monooleate, sorbitan monostearate, glycerol monostearate, polyoxyethyl stearate, alkylphenol polyglycol ethers; ampholytic surfactants such as di-sodium N-lauryl-.beta.-iminodipropionate or lecithin; anionic surfactants such as Na lauryl sulphate, fatty alcohol ether sulphates, the monoethanolamine salt of mono/dialkyl polyglycol ether orthophosphoric esters; cationic surfactants such as cetyltrimethylammonium chloride, combinations thereof, and derivatives thereof. Especially preferred are polymeric emulsifiers, which are copolymers of acrylic acid, modified by long chain (C₁₀₋₃₀) alkyl acrylates, and crosslinked with allylpentaerythritol. Within this group or polymeric emulsifiers the pemulens are most preferred. Pemulen polymeric emulsifiers are copolymers of acrylic acid, modified by long chain (C10-C30) alkyl acrylates, and crosslinked with allylpentaerythritol. Pemulen polymeric emulsifiers are commercially available from different sources.

In another embodiment of the present invention the inventive formulation comprises one or more suitable preservatives in the range of 0.35-0.60% (w/v), preferably 0.40-0.50% (w/v), ideally about 0.45% (w/v).

Examples of the suitable preservatives are benzoic acid, the sodium and other salts of benzoic acid, alkyl hydroxybenzoates such as propyl hydroxybenzoate and methyl hydroxybenzoate, the sodium, calcium and other salts (propionates) of propionic acid, sorbic acid, the potassium, calcium and other salts (sorbates) of sorbic acid, diethyl pyrocarbonate and menadione sodium bisulfite and combinations thereof. Most preferred are alkyl hydroxybenzoates such as propyl hydroxybenzoate and methyl hydroxybenzoate.

In another embodiment of the present invention the inventive formulation comprises the synergist in the range of 0.01-0.09% (w/v), preferably 0.03-0.07% (w/v), ideally about 0.05% (w/v).

A suitable synergist is EDTA (ethylenediaminetetraacetic acid). EDTA (ethylenediamine-tetraacetic acid) is a common sequestrant and antioxidant added to foods, body care, and household products. It occurs as disodium calcium EDTA, tetrasodium EDTA, and disodium dihydrogen EDTA. As a sequestrant, it binds trace minerals such as copper, iron and nickel that may be in the product. EDTA prevents oxygen from causing color changes and rancidity.

In another embodiment of the present invention the inventive formulation comprises the antioxidant in the range of 0.01-0.09% (w/v), preferably 0.03-0.07% (w/v), ideally about 0.05% (w/v).

The preferred antioxidant is BHT Antioxidant CaO-3, which is butylated hydroxytoluene 2,6-di-tert-butyl-p-cresol (DBPC) [CAS Number: 128-37-0].

In another embodiment of the present invention the inventive formulation comprises the oily component in the range of 5.0-20.0% (w/v), preferably 7.0-15.0% (w/v), ideally about 10% (w/v).

In another embodiment of the present invention the inventive formulation comprises the solvent in the range of 5.0-30.0% (w/v), preferably 10.0-25.0% (w/v), ideally about 20% (w/v).

Examples of suitable solvents of the preferred embodiment include but are not limited to, polyvinyl pyrrolidone and glycols, such as propylene glycol (PG), polyethylene glycol (PEG), butylene glycol (BG) and ethylene glycol (EG), combinations thereof, and derivatives thereof. Said glycols are widely used as solvents in cosmetics, in the pharmaceutical and food industries. Propylene glycol is the most preferred solvent.

Propylene Glycol USP/EP is designed for foods, pharmaceuticals, cosmetics, and other applications involving possible ingestion or absorption through the skin. Propylene Glycol USP/EP is tested for and meets the requirements of the Food Chemicals Codex (FCC), the United States Pharmacopoeia (USP), European Pharmacopoeia (EP), and Japanese Pharmacopoeia (JP). Propylene Glycol USP/EP also complies with the Brazilian Pharmacopoeia (FB) monograph. Propylene Glycol is odorless and colorless, has a wide range of solvency for organic materials, and is completely water soluble. It is a known antimicrobial and is effective as a food preservative.

In another embodiment of the present invention the inventive formulation comprises the antifoaming agent in the range of 0-0.05% (w/v), preferably 0.2-0.4% (w/v), ideally about 0.03% (w/v).

In another embodiment of the present invention the inventive formulation comprises the thickener in the range of 0-4.0% (w/v), preferably 1.0-3.0% (w/v), ideally about 2.0% (w/v).

The following thickeners represent examples of a preferred embodiment of the present invention. Examples of thickeners suitable for the aqueous phase include natural or chemically modified elastomers, but are not limited to, agar-agar, agarose, agaropectin, alginic acid and its salts and derivatives, acacia gum, carboxymethylcellulose, carob gum, carrageenan, corn syrup, deacetylated chitin, dextran, gellan gum, guar gums (natural or synthetic), gum arabic, gum ghatti, gum karaya, gum tragacanth, high and low methoxyl pectins, hydroxyethylcellulose, konjac gum, locust bean gum, maltodextrin, pectin, polyvinyl alcohol, propylene glycol aliginate, sodium carboxymethylcellulose, sodium alginate, tamarind gum, xanthan gum, combinations thereof, and derivatives thereof. Suitable thickeners for the oily phase include inorganic thickeners such as bentonites, colloidal silica, aluminium monostearate, organic thickeners such as monoglycerides, for example Myverol®, cellulose derivatives, polyvinyl alcohols and their copolymers, acrylates, methacrylates and Aerosil® (Degussa, Technical Bulletin Pigments, No. 11 and No. 49). Even though the term thickener is used, the thickeners of the present invention also have a stabilizing and gelling function.

In another embodiment of the present invention the inventive formulation comprises the coloring agent in the range of 0-0.05% (w/v), preferably 0.005-0.02% (w/v), ideally about 0.01% (w/v).

Suitable coloring agents are ferric oxide, titanium oxide, prussian blue, alizarin dye, azo dye, phthalocyanine dye and so on. Most preferred are Brilliant Scarlet 4R Cl 16255, which is also known as Acid Red 41; Food Red 8; Scarlet 4R; C.l. 16255; or E-124 and Brilliant Blue G-250.

In another embodiment of the present invention the inventive formulation comprises the neutralizer(s) in the range of 0-0.06% (w/v), preferably 0.01-0.05% (w/v), ideally about 0.03% (w/v).

The present invention will now be described in greater detail with the aid of non-limiting embodiment examples.

### FORMULATION EXAMPLES

| | Formulation | Formulation | Formulation |
|---|---|---|---|
| Ingredients | A | B | C |
| Diflubenzuron | 1.50% | 1.50% | 1.50% |
| Dicyclanil | 5.00% | 5.00% | 5.00% |
| Excipients | | | |
| Polysorbate 20 | 0.25% | 0.25% | 0.25% |
| Pemulen ® TR-2NF | 0.11% | 0.112% | 0.08% |
| Propyl hydroxybenzoate | 0.45% | 0.30% | 0.30% |
| Methyl hydroxybenzoate | | 0.15% | 1.15% |
| Disodium edatate | 0.05% | 0.05% | 0.05% |
| dihydrate BP | | | |
| BHT Antioxidant CaO-3 | 0.05% | 0.05% | 0.05% |
| Xantham gum | 2.80% | 0.04% | — |
| Glyceryl tricaprylate | 10.0% | 10.00% | 10.00% |
| Propylene Glycol USP | 20.0% | 20.00% | 20.00% |
| Dye: Brilliant Scarlet ® | 0.005% | 0.005% | 0.01% |
| 4R Cl 16255 or Brilliant | | | |
| Blue ® | | | |
| Sodium hydroxide | 0.03% | 0.034% | 0.034% |
| Myverol ® 18-92 | 0.03% | 2.80% | 2.00% |
| Water q.s | q.s | q.s | q.s |

The inventive formulations may be prepared In four stages. A gel phase is prepared by mixing solvent, preservative and suitable emulsifier with water. This mixture is then transferred to the main mixing tank. An oily phase is prepared by combining a triglyceride oil with antioxidant, preservative and a thickener/stabilizer. After mixing the oily phase is transferred to the main mixing tank where it is mixed with the gel phase. The active phase is prepared by combining the synergist, solvent, surfactant and active ingredients with water. When a lump free suspension is obtained the phase is milled and fed into the main tank with the other phases. The final stage is the addition of the coloring agent, adjustment of pH and adjustment to final volume with water.

Alternatively, if the surfactant concentration is high the following method consisting of five stages may be adopted.

A diflubenzuron suspension concentrate may be prepared by combining diflubenzuron with a solvent, preservative, antifoam and surfactants. After mixing the viscosity is adjusted with a suitable emulsifier and, if necessary, the pH adjusted with a neutralizer. This suspension concentrate is diluted further at a latter stage. A dicyclanil intermediate is prepared by charging dicyclanil into a pre-mix of triglyceride oil, antioxidant, preservatives and surfactants. The diflubenzuron intermediate is then diluted to its final concentration in a water, synergist mixture. Suspoemulsion blending then occurs. Solvent, preservative, water and an emulsifier are combined and mixed. To this mixture the dicyclanil intermediate and the diflubenzuron suspension concentrate dilution are added. After mixing the coloring agent is added, the pH of the final product is adjusted with neutralizer and the viscosity adjusted with an emulsifier.

Thus, the manufacturing of the inventive formulation comprises
(a) the preparation of a gel phase by mixing suitable solvent, preservative and emulsifier with water;
(b) the preparation of an oily phase by combining a suitable triglyceride oil with antioxidant preservative and a thickener and/or stabilizer;
(c) and transferring said gel phase and said oily phase to a mixing tank and homogenizing both phases;
(d) the preparation of the active phase is prepared by mixing a synergist, solvent, surfactant and the active ingredients with water and milling the mixture until a lump free suspension is obtained;
(e) the preparation of the final formulation by mixing the homogenized phase of step (c), the active phase of step (d) and the coloring agent;
(f) adjustment of pH, and
(g) adjustment to final volume with water.

### Manufacturing Example

Preparation of a 1000 Liter Batch

A 1000 Liter batch of the inventive formulation can be prepared in the following manner.

Phase 1: 160.00 kg of propylene glycol is added to a clean tank of suitable volume (250-400 Liter). Whilst the propylene glycol is stirred constantly, 1.50 kg of methyl hydroxybenzoate is added in small portions. The resulting mixture is stirred for another 20 minutes in order to complete the dissolution. Then 30 liter of water is added and the mixture is stirred for another five minutes. The mixture is then transferred to a homogeniser (1400 rpm fixed speed). While mixing, 1.12 kg Pemulen® TR-2 NF is added and the mixture is again stirred for about 10 minutes until a smooth dispersion is obtained. The resulting phase 1 is then transferred to a clean tank of suitable volume.

Phase 2: 100.00 kg of pre-warmed (40° C.) glycerol tricaprylate, 0.50 kg butylated hydroxytoluene antioxidant CAO-3® and 3.00 kg propyl hydroxybenzoate are added to a clean tank of suitable volume and mixed for about 20 minutes. Afterwards 28.00 kg of pre-melted (40° C.) Myverol® 18-92 is added in small portions and the resulting mixture is stirred for about 30 minutes. Then phase 2 is added to phase 1 and the mixture is stirred for another 10 minutes.

Phase 3: 200 liter of water is added to a clean tank of suitable volume. While stirring 0.50 kg disodium edetate dihydrate BP, 40.00 kg propylene glycol, 2.50 kg Polysorbate 20, 50.00 kg dicyclanil and 15.00 kg diflubenzuron are added in smaller portions to the water. The resulting composition is stirred until a lump free suspension is obtained. The phase is then milled through an appropriate mill with medium feed rate into the tank holding the combined phases 1 and 2 while stirring.

Final mixing and adjustment: To the combined phases 0.10 kg of Brilliant Blue dye is added and water is added to the 1000 Liter mark. The mixture is stirred for about 20 minutes and the pH value is measured and, if necessary, adjusted to the required range of 6.8-7.2 by adding aqueous 10% sodium hydroxide solution. In a last step water is added to the 1000 liter mark and the final mixture is stirred for about 30 minutes before packing off.

### BIOLOGICAL EXAMPLES (EFFICACY)

### Example 1

### Blowfly Efficacy Test in Sheep

a) Prophylactic Treatment to Prevent Flystrike

ILarge-scale field evaluations can be conducted to evaluate the efficacy against blowflies. In such cases large numbers of sheep in different geographic zones are treated with the inventive product (at the normal label dose rate) just prior to or during the blowfly season. The sheep are then inspected at regular intervals to detect blowfly strikes when they occur. When the cumulative number of flystrikes exceeds a strike rate figure set by the governing regulatory authority (e. g. 1 or 2% of the flock) the product is deemed to have ‘lost protection’. It is on this data that ‘protection periods’ against flystrike will be determined. Animals found to be flystruck are treated with a registered fly dressing to resolve the strike.

In a series of field trials in Australia, 8650 sheep (at 11 different sites) were treated with the invention or a currently registered product, used as a positive control. The invention was highly effective in preventing blowfly strike for a period of 18-24 weeks. Moreover, resistance testing of the blowfly populations confirmed that the flies were representative of the more organophosphate (diazinon) resistant populations found in Australia, with some cross-resistance to diflubenzuron. Each of the populations tested was susceptible to the invention, confirming the data presented earlier in this document.

### Example 2

### Sheep Body Louse Efficacy Test (Activity Against Bovicola ovis)

Curative Treatment

Lice to be used for a dose confirmation efficacy trial can either be harvested from the wool of louse-infested sheep and artificially administered to treated sheep or alternatively louse-infested sheep can be treated with a test product directly.

In this dose confirmation test five groups of six louse-infested sheep are used. Three groups are treated with the test product at the proposed minimum dose rate; one group is treated with the invention at the proposed ‘normal label’ dose rate; and one group is left untreated and serves as the control. Two groups of treated sheep will be exposed to rainfall (about 25 mm) either prior to treatment (i. e. treated with wet wool) or after treatment (to test rainfastness of the invention). Each group of sheep is kept in an isolated pen or small paddock for the duration of the trial (at least 20 weeks but preferably up to 52 weeks). Louse counts are conducted at pre-defined intervals during the study.

Calculations to establish the efficacy of a treatment are used to report the results of the trial. The figures used in the calculations are: (1) Estimated Total Louse Population per Individual and (2) Mean Louse Population per Group. Within a treatment group, the Estimated Total Louse Populations are added and the figure is divided by the number of sheep in the group to estimate the Mean Louse Population per Group. Then the percent control is calculated in accordance with the formula of Roulston et al (1968)

$$\% Control = 100 \times \frac{1 - ( Ta \times Cb )}{( Tb \times Ca )}$$

Where Tb=Mean number of lice counted on the treated sheep before treatment (commencement of study); Ta=Mean number of lice counted on the treated sheep after treatment; and Cb=Mean number of lice counted on the control sheep at the commencement of the study. Ca=Mean number of lice counted on the control sheep at the same time as Ta.

Estimation of the total louse population is carried out by individually restraining each sheep. Twenty wool partings each 10-cm long vertically down each side of the sheep are searched for lice. The 40 partings are evenly spaced over the sides of the sheep, starting from the shoulder and finishing at the rump. The wool is parted down to skin level and all live lice (immature and mature) observed along the length of the wool parting are counted. The number of lice sighted in each parting is recorded.

Assessments are always carried out on untreated controls before treated sheep to avoid chemical contamination of the handling facilities and the assessors.

Efficacy (%)

| | | | | | Week |
|---|---|---|---|---|---|
| Treatment | Week 7* | Week 12 | Week 20 | Week 30 | 41 |
| Minimum dose | 85.4 | 99.2 | 100 | 100 | 100 |
| Normal dose | 92.7 | 99.5 | 100 | 100 | 100 |

| | | | | |
|---|---|---|---|---|
| Rain pre-treat | 93.2 | 99.3 | 100 | Discarded groups |
| Rain post-treat | 96.9 | 98.9 | 100 | |

*week post-treatment

As discussed previously, the lousicide component of the invention is diflubenzuron. The insecticidal action of diflubenzuron is due to interference with chitin synthesis and/or deposition. A failure to synthesize chitin halts the molting process in juvenile lice ultimately leading to the death of the insect. However, as a consequence of its mode of action only immature stages of the parasite are killed by the treatment. Therefore importantly, all lice detected on the treated sheep at week 12 in the described trial were adults. No juveniles were observed.

The invention when applied as a spray-on after shearing at the minimum dose demonstrated a very high efficacy against the sheep biting louse (B. ovis). Rainfall pre- or post-treatment had no negative effect on efficacy.

Large-scale field evaluations are also completed in the evaluation of a product such as the invention. Flocks of louse-infested sheep (about 1000 sheep per flock) are treated with the test product at the proposed normal dose rate and a representative group of sheep is then inspected (as described above) at regular intervals after treatment to confirm efficacy. Such a trial should progress for at least 20 weeks.

A study conducted across three commercial farms utilizing 3300 Merino sheep was conducted. The high efficacy of the test product against sheep biting lice populations was confirmed.

Efficacy (%)

| Site | Week 6* | Week 12 | Week 20 | Week 23 |
|---|---|---|---|---|
| 1 | 98.5 | 99.9 | 99.98 | 100 |
| 2 | 99.8 | 99.98 | 100 | NE |
| 3 | 98.5 | 99.8 | 99.97 | 100 |
| Mean | 98.9 | 99.9 | 100 | 100 |

*week post-treatment
NE = not evaluated

The 100% efficacy exhibited in the field evaluation within 5-6 months of treatment confirms the product is suitable for successfully controlling louse infestations.

1-22. (canceled)

23. A composition for controlling insect pests on a mammal comprising an insecticidally effective amount of diflubenzuron and dicyclanil and suitable carriers or diluents.

24. The composition of claim 23 wherein said composition is a topical formulation.

25. The composition of claim 23 wherein said composition is an oil-in-water or an water-in-oil suspoemulsion.

26. A composition for controlling louse infestations and preventing blowfly strikes on sheep and goats comprising an insecticidally effective amount of diflubenzuron, an insecticidally effective amount of dicyclanil, a surfactant, an emulsifier, a preservative, a synergist, an antioxidant, an oily component, a solvent, a thickener, a neutralizer, and optionally one ore more excipients selected from the group consisting of a coloring agent, and an antifoaming agent, whereby said composition is an a pour-on, spot-on, or spray-on formulation.

27. The composition of claim 26 wherein said diflubenzuron is in the range of about 0.05 to about 2.5% (w/v) and said dicyclanil is in the range of about 4.0 to about 6.0% (w/v).

28. The composition of claim 26 wherein said surfactant is in the range of about 0.15 to about 10.0% (w/v).

29. The composition of claim 26 wherein said emulsifier is in the range of about 0.01 to about 0.30% (w/v).

30. The composition of claim 26 wherein said preservatives are in the range of about 0.35 to about 0.60% (w/v).

31. The composition of claim 26 wherein said synergist is in the range of about 0.01 to about 0.09% (w/v).

32. The composition of claim 26 wherein said antioxidant is in the range of about 0.01 to about 0.09% (w/v).

33. The composition of claim 26 wherein said oily component is in the range of about 5.0 to about 20.0% (w/v).

34. The composition of claim 26 wherein said solvent is in the range of about 5.0 to about 30.0% (w/v).

35. The composition of claim 26 wherein said antifoaming agent is in the range of about 0 to about 0.05% (w/v).

36. The composition of claim 26 wherein said thickener is in the range of about 0 to about 4.0% (w/v).

37. The composition of claim 26 wherein said coloring agent is in the range of about 0 to about 0.05% (w/v).

38. The composition of claim 26 wherein said neutralizer is in the range of about 0 to about 0.06% (w/v).

39. The composition of claim 26 wherein said diflubenzuron is in the range of about 0.05 to about 2.5 % (w/v), said dicyclanil is in the range of about 4.0 to about 6.0% (w/v), said surfactant is in the range of about 0.15 to about 10.0% (w/v), said emulsifier is in the range of about 0.01 to about 0.30% (w/v), preservatives are in the range of about 0.35 to about 0.60% (w/v), said synergist is in the range of about 0.01 to about 0.09% (w/v), said antioxidant is in the range of about 0.01 to about 0.09% (w/v), said oily component is in the range of about 5.0 to about 20.0% (w/v), said solvent is in the range of about 5.0 to about 30.0% (w/v), said antifoaming agent is in the range of about 0 to about 0.05% (w/v), said thickener is in the range of about 0 to about 4.0% (w/v), said coloring agent is in the range of about 0 to about 0.05% (w/v), and said neutralizer is in the range of about 0 to about 0.06% (w/v).

40. A method of simultaneously controlling louse infestations and preventing blowfly strikes on sheep and goats, the method comprising topically administering the composition of claim 26 to said sheep or said goats.

41. The method of claim 40 whereby in said composition of claim 26, said diflubenzuron is in the range of about 0.05 to about 2.5% (w/v), said dicyclanil is in the range of about 4.0 to about 6.0% (w/v), said surfactant is in the range of about 0.15 to about 10.0% (w/v), said emulsifier is in the range of about 0.01 to about 0.30% (w/v), preservatives are in the range of about 0.35 to about 0.60% (w/v), said synergist is in the range of about 0.01 to about 0.09% (w/v), said antioxidant is in the range of about 0.01 to about 0.09% (w/v), said oily component is in the range of about 5.0 to about 20.0% (w/v), said solvent is in the range of about 5.0 to about 30.0% (w/v), said antifoaming agent is in the range of about 0 to about 0.05% (w/v), said thickener is in the range of about 0 to about 4.0% (w/v), said coloring agent is in the range of about 0 to about 0.05% (w/v), and said neutralizer is in the range of about 0 to about 0.06% (w/v).

42. A method of simultaneously controlling louse infestations and preventing blowfly strikes on sheep and goats, the method comprising topically administering the composition of claim 23 to said sheep or said goats.

43. A method for the preparation of the composition of claim 26 comprising
(a) mixing the solvent, the preservative, and the emulsifier with water to prepare a gel phase;
(b) combining the oily component with the antioxidant, the preservative and the thickener to prepare an oily phase;
(c) homogenizing said gel phase with said oily phase;
(d) mixing the synergist, the solvent, the surfactant, diflubenzuron and dicyclanil with water to prepare the active phase;
(e) milling the active phase;
(f) mixing the homogenized phase of step (c) and the milled active phase of step (e) and, optionally, the coloring agent; and
(f) optionally, adding the neutralizer to adjust the pH and water to adjust to the final volume.

44. A method for the preparation of the composition of claim 26 comprising
(a) mixing diflubenzuron, the solvent, the preservative, the antifoaming agent, and the surfactant to form the diflubenzuron suspension;
(b) adding the emulsifier and, optionally, the neutralizer to adjust the pH to the diflubenzuron suspension;
(c) mixing the oily component, the antioxidant, the thickener, and the surfactant to obtain a pre-mix;
(d) charging dicyclanil into the pre-mix of step (c) to obtain a dicyclanil intermediate;
(e) diluting to a final concentration the diflubenzuron suspension of step (b) with water and the synergist;
(f) blending the diflubenzuron suspension of step (e);
(g) combining the solvent, the preservative, water and the emulsifier to form the second pre-mix;
(h) mixing the dicyclanil intermediate of step (d) and the blended diflubenzuron suspension of step (f) with the second pre-mix of step (g); and
(i) adding the optional coloring agent, the neutralizer to adjust the pH, and the emulsifier to adjust the viscosity to the mixture of step (h).
